(19) United States
(12) Patent Application Publication
(10) Pub. No.: US 2026/0044021 A1
(43) Pub. Date: Feb. 12, 2026

(54) A TECHNIQUE FOR VISUALIZING DIFFERENT VISION ZONES ON AN OPHTHALMIC LENS, AN OPHTHALMIC DEVICE AND AN ASSEMBLY THEREOF

(71) Applicant: SHAMIR OPTICAL INDUSTRY LTD., Kibbutz Shamir (IL)

(72) Inventors: Zohar KATZMAN, Haifa (IL); Alexander SHUR, Haifa (IL); Amnon KANTER, Kibbutz Lehavot HaBashan (IL); Zohar KADMON, Kibbutz Shamir (IL); Ariel HAMMERSCHLAG, Kibbutz Shamir (IL)

(21) Appl. No.: 19/101,375

(22) PCT Filed: Jul. 24, 2023
(86) PCT No.: PCT/IL2023/050773

§ 371 Date: Feb. 5, 2025

(30) Foreign Application Priority Data
Aug. 8, 2022 (IL) 295466

(51) Int. Cl. G02C 7/06; G02C 7/02

(52) U.S. Cl. CPC G02C 7/066; G02C 7/027

(57) ABSTRACT

The present disclosure relates to a method for visualizing different vision zones on an ophthalmic lens. The method comprises receiving a calculated optical design profile being indicative of a specific patient's correction; creating a physical representation data of the optical design profile corresponding to a personalized optical design profile; wherein the optical design profile is configured and operable to enable design profile visualization and to identify main vision zones including far and near vision zones. There is also provided an ophthalmic device comprising a lens having a front and a back surface and a personalized optical design profile being applied onto at least one front or a back surface, wherein the personalized optical design profile is configured and operable to enable design profile visualization and to identify main vision zones including far and near vision zones.

### TECHNOLOGICAL FIELD

The present disclosure is in the field of designing ophthalmic lenses. More specifically, the present disclosure relates to a method for visualizing different vision zones on an ophthalmic lens, to an ophthalmic device, and an assembly thereof.

### BACKGROUND

There are various kinds of spectacle lenses including single vision lenses, bifocal lenses, trifocal lenses, progressive addition lenses, or extended focus lenses. The progressive addition lenses (called also multifocal lenses) are designed with a smooth progression from a distance prescription from the upper section of the lens, down to a near prescription. This enables the wearer to see all the way from the distance, up to near focus lengths, and everything in between. Progressive addition lenses have become the lens of choice for most people with presbyopia as it helps the viewer see all focus distances without a visible line. The Progressive Addition Lens (referred to hereinafter as PAL) is formed so that “a distance vision zone” for providing the specified distance prescription, “a near vision zone” for providing the specified add power for near vision prescription, and “an intermediate (progressive) zone” in which the power is gradually increasing between the distance vision zone and the near vision zone, are arranged in one lens.

Regarding such a progressive addition lens, when a power distribution is designed on the lens, variation of powers is imparted to the progressive addition lens according to a specific power variation curve, from the distance vision zone at an upper part of the lens toward the near vision zone at a lower part of the lens in a using state of the lens. Then, regarding the power distribution in a horizontal direction (right and left direction) in the using state of the lens, it is general to make the power varied while securing a required wideness of a visual field. More specifically, for example in the near vision zone, horizontal power distribution is set so as to gradually decrease toward both sides, with a near vision passing point at a peak on the corridor. Although powers of the right and left lenses are decreased at the same ratio basically, the power gradient at the nasal side can be relatively steeper than the power gradient at the temporal side in relation to the inset.

However, PAL might generate aberrations blur that in particular reduces the field of view and lead to distortion that creates for example the well-known swim effect. More specifically, most points on the lens surface have some degree of the cylinder (i.e. surface astigmatism), due to the varying curvature. The surface astigmatism varies across the surface: relatively low in the intermediate zone but gradually increases into the blending regions on the sides, creating a higher level of unwanted astigmatism that might be perceived by the wearer as blur, distortions, and image swim. The design is necessarily a compromise between these aberrations. It is also known for some design features of a progressive lens to be adapted according to a wearer for whom the lens is designed, in particular in order to reduce the time that could be required for the wearer to become accustomed to this progressive lens.

### General Description

Many patients experience adaptation problems when they are fitted with glasses. This is especially true when wearing PALs (Progressive Addition Lenses). Thus, adaptation to a new lens is a common problem among patients, especially those who are prescribed with a PAL for the first time. One of the main reasons for discomfort is the patient's lack of understanding of the lens design and how to gaze through the various vision zones optimally. It should be understood that the lens optical design is not easy to explain orally without showing a clear visualization of the optical profile. Even if such visualization is provided to the patient in the form of optical mappers (such as DLM and the like) on a computer screen or as a hard copy before the wearing of the glasses, this would not render the adaptation to the new lens easier, since the exposure to the optical profile would be too brief for the patient. Moreover, several optical designs may be proposed to the patient. To be able to choose between them, commercially available clever tools try to explain the difference between them and demonstrate the advantage of one optical design over the other. It is conventionally done by providing a comparison of optical analysis which requires experience and expertise. Therefore, there is a need in the art to represent the optical profile on the lens surface to simplify the design layout and make it intuitive and easy to explain. The design drawings can help a patient to better understand the lens design and how to optimally use his glasses. A better knowledge of the lens design and correct gazing through lens optical zones enables to reduce the number of complaints and increase customer satisfaction. In particular, it should be noted that the optical profile of each PAL is different. The profiles of the design on the lens surface are affected by the optical design, patient prescription, frame, and other aspects. Typically, the optics of a PAL can be (and is usually) represented by using a map of contour plots. The map indicates how the optical characteristics vary across the lens surface: A cylinder map represents the regions of potential blur/distortion and is useful in predicting the width and size of the visual zones and a power contour map represents the distribution of the add power across the lens and indicates the location of the near vision zone.

Therefore, according to a broad aspect of the present disclosure, there is provided a method for visualizing different vision zones on an ophthalmic lens. The method comprises receiving a calculated optical design profile being indicative of a specific patient's correction; creating a physical representation data of the optical design profile corresponding to a personalized optical design profile; wherein the optical design profile is configured and operable to enable design profile visualization and to identify main vision zones including far and near vision zones. The term “profile” refers hereinafter to the shape (e.g. size and width) of the plurality of regions as defined by the contour plots. The technique of the presently disclosed subject matter is configured for marking each lens with the unique design profiles with which it was calculated.

In some embodiments, the personalized optical design profile comprises a plurality of contours representing a contour map defining different optical regions having different parameters of the optical design profile and a plurality of regions defined in between the contours.

In some embodiments, the method further comprises coloring or patterning the plurality of regions defined in between the optical design contours. The coloring or patterning of the plurality of regions defined in between the optical design contours may comprise marking the plurality of regions having different parameters differently. The plurality of contours may comprise a cylinder contour or a power contour.

In some embodiments, the method further comprises applying the physical optical design profile onto at least a portion of at least one front or back surface of the lens.

The marking may be temporary or permanent. The temporary markings enable to configure the lens according to the wearer's prescription and provide it with temporary markings as an adaptation tool. After the wearer is well adapted, he can just remove the stickers/removable ink. Permanent markings generally serve as a demo tool at the ECP store (on Plano lenses, for example). The marking of the lens may be implemented by drawing/printing the design profiles onto the lens surface. The drawing/printing can be either of the cylinder profile or the power profile. The cylinder lines are indicative of the regions through which the patient should not look while the power lines are indicative of the regions through which the patient should look. The design profiles can be drawn/printed personally and uniquely to each order of lenses via a lens design control unit. The profiles printed on each lens are thus individual (not generic or pre-made) but considering the optical design, patient prescription, frame, and other aspects.

In some embodiments, the method further comprises applying the physical optical design profile onto the at least one front or back surface comprises printing the physical optical design profile onto the at least one front or back surface.

In some embodiments, the method further comprises applying the physical optical design profile onto the at least one front or back surface comprises applying a physical permanent optical design profile onto the at least one front or back surface.

In some embodiments, the method further comprises applying the physical permanent optical design profile onto the at least one front or back surface comprises engraving a physical optical design contour onto the at least one front or back surface mechanically or by using a laser.

In some embodiments, the method further comprises applying the physical optical design profile onto the at least one front or back surface comprises attaching a physical temporary optical design profile onto the at least one front or back surface.

In some embodiments, the method further comprises attaching the physical temporary optical design profile onto the at least one front or back surface comprises attaching an adhesive physical optical design profile onto the at least one front or back surface.

In some embodiments, the method further comprises attaching the physical temporary optical design profile onto the at least one front or back surface comprises attaching a plurality of elements being indicative of a plurality of regions forming the optical profile together on the at least one front or back surface.

In some embodiments, the method further comprises attaching the physical temporary optical design profile onto the at least one front or back surface comprises attaching a plurality of elements being indicative of a plurality of regions forming the optical profile separately on the at least one front or back surface.

In some embodiments, the method further comprises calculating an optical design profile being indicative of a specific patient's correction.

The presently disclosed subject matter may help ECPs (Eye-Care Professionals) to clarify, educate and demonstrate the right practice for the glasses and/or differences between optical designs. By showing to the patient the main vision zones, the ECP is able to clearly explain to the patient how to look through the lens effectively, where the main vision zones are, how to move from far vision to near vision and how to utilize the lens optimally in daily activity. Lenses with different designs can be manufactured and marked with their respective design profiles. The differences between the designs are then visible and the properties of the various designs are then easier to show and explain.

The patient may be trained as follows: when the patient arrives at the ECP to receive his finished eyeglasses, the ECP may provide him with the glasses that are either marked with removable ink or with stickers. He explains to the patient how to gaze through the lenses according to the marked contours: if the markings/stickers represent the cylinder plots, he is instructed to gaze through the remaining clear parts of the lens; if the markings/stickers represent the power plots, he is instructed to gaze from far to the marked part of the near vision zone. He is supposed to gaze according to the ECP's instructions for a few minutes to adjust (meaning, he can see clearly and “switch” through the zones effortlessly without blur/swim) and when he is satisfied with the experience the ECP can erase the ink markings/take off the stickers.

According to another broad aspect of the present disclosure, there is provided an ophthalmic device comprising a lens having a front and a back surface and a personalized optical design profile being applied onto at least one front or a back surface, wherein the personalized optical design profile is configured and operable to enable design profile visualization and to identify main vision zones including far and near vision zones.

In some embodiments, the personalized optical design profile comprises a plurality of contours representing a contour map defining different optical regions having different parameters of the optical design profile and a plurality of regions defined in between the contours. The plurality of contours may comprise cylinder contour or power contour. The personalized optical design profile may be colored or patterned. The plurality of regions being indicative of different parameters of the optical design profile may be marked differently. The personalized optical design profile may be printed onto the at least one front or a back surface.

In some embodiments, the personalized optical design profile is permanent e.g. it may be engraved within the at least one front or a back surface.

In some embodiments, the personalized optical design profile is temporary e.g. it may comprise an adhesive layer defining physical optical design profile. The adhesive physical optical design profile may comprise a glue layer being capable of coupling between the personalized optical design profile and the at least one front or a back surface. Additionally or alternatively, the adhesive physical optical design profile may comprise a carrier layer being capable of carrying the physical optical design profile and being removed upon attaching the personalized optical design profile onto the at least one front or a back surface.

In some embodiments, at least one of the personalized optical design profile or the at least one front or a back surface comprises at least one mark being configured to precisely align between the personalized optical design profile and the at least one front or a back surface.

In some embodiments, the ophthalmic device further comprises a frame holding the lens, wherein an external contour of the personalized optical design profile is configured to correspond to an internal shape of the frame. The external contour of the personalized optical design may be configured to be precisely aligned with the internal shape of the frame.

In some embodiments, the personalized optical design profile may comprise a plurality of elements configured to be applied together on the at least one front or a back surface. The personalized optical design profile may comprise a plurality of elements configured to be applied separately on the at least one front or a back surface.

In some embodiments, the lens comprises progressive addition lens.

According to another broad aspect of the present disclosure, there is provided an assembly to be applied on a front or a back surface of a lens. The assembly comprises a carrier layer being capable of carrying a personalized optical design profile, wherein the personalized optical design profile is configured and operable to enable design profile visualization and to identify main vision zones including far and near vision zones. The personalized optical design profile may comprise a plurality of contours representing a contour map defining different optical regions having different parameters of the optical design profile and a plurality of regions defined in between the contours. The plurality of contours may comprise cylinder profile or power profile. The personalized optical design profile may be colored or patterned. The plurality of regions being indicative of different parameters of the optical design profile may be marked differently.

In some embodiments, the assembly further comprises a glue layer being capable of coupling between the personalized optical design profile and at least one front or a back surface. The carrier layer may be capable of being removed upon attaching the personalized optical design profile onto at least one front or a back surface. The personalized optical design profile may comprise at least one mark being configured to precisely align between the personalized optical design profile and at least one front or a back surface. The external contour of the personalized optical design may be configured to be precisely aligned with an internal shape of a frame of a lens. The personalized optical design profile may comprise a plurality of elements configured to be applied together on at least one front or a back surface. Alternatively, the plurality of elements may be configured to be applied separately on at least one front or a back surface.

According to another broad aspect of the present disclosure, there is provided a system for designing ophthalmic lenses. The system comprises a control unit being configured and operable to receive a calculated optical design profile being indicative of a specific patient's correction; creating a physical representation data of the optical design profile corresponding to a personalized optical design profile; wherein the optical design profile is configured and operable to enable design profile visualization and to identify main vision zones including far and near vision zones. Creating a physical representation data of the optical design profile may comprise providing a design data being indicative of the marking of the plurality of regions defined in between the optical design contours differently and/or creating a cylinder profile or a power profile.

In some embodiments, the personalized optical design profile comprises a plurality of contours representing a contour map defining different optical regions having different parameters of the optical design profile and a plurality of regions defined in between the contours.

In some embodiments, the system further comprises a communication interface being configured for sending design data being indicative of the physical representation data of the optical design profile to a design production system.

In some embodiments, the control unit is configured and operable to calculate an optical design profile being indicative of a specific patient's correction.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a flow chart illustrating the main principal steps of the method for visualizing different vision zones on an ophthalmic lens according to some embodiments of the presently disclosed subject matter;

FIG. 2 is a flow chart illustrating examples of a method for visualizing different vision zones on an ophthalmic lens according to some embodiments of the presently disclosed subject matter;

FIG. 3 is a functional block diagram illustrating the main functional part of the system for designing ophthalmic lenses according to some embodiments of the presently disclosed subject matter.

FIG. 4 is an example of an ophthalmic device including a personalized optical design profile being capable of being applied on a front or a back surface of a lens according to some embodiments of the presently disclosed subject matter;

FIG. 5 is an example of an assembly being capable of being applied on a front or a back surface of a lens according to some embodiments of the presently disclosed subject matter;

FIGS. 6A-6C is an example of a method of applying the assembly of FIG. 5 according to some embodiments of the presently disclosed subject matter;

FIG. 7 shows an ophthalmic device including an assembly similar to the one of FIG. 5 being applied on the front surface of the lens according to some embodiments of the presently disclosed subject matter;

FIG. 8A shows an uncut lens including a personalized optical design profile being applied on the front surface of the lens according to some embodiments of the presently disclosed subject matter; and

FIG. 8B shows an ophthalmic device including a printed assembly being applied on the front surface of the lens according to some embodiments of the presently disclosed subject matter.

### DETAILED DESCRIPTION OF EMBODIMENTS

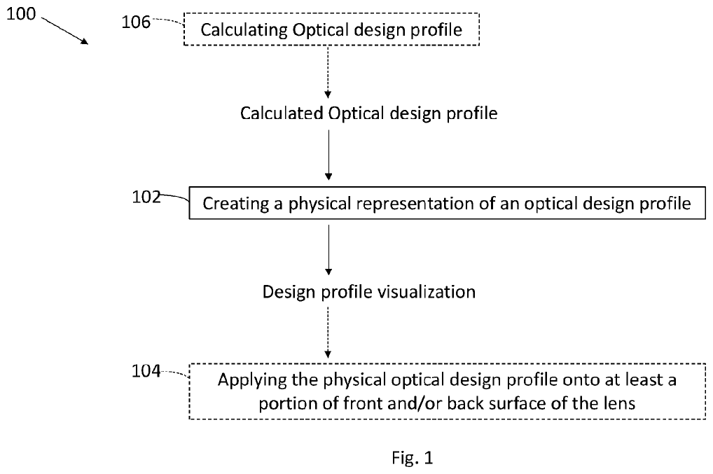

Reference is made to FIG. 1, showing a flow chart illustrating the main steps of a method for visualizing different vision zones on an ophthalmic lens. Method 100 may include receiving a calculated optical design profile being indicative of a specific patient's correction and creating a physical representation data of the optical design profile corresponding to a personalized optical design profile in 102. The optical design profile is configured and operable to enable design profile visualization and to identify main vision zones including far and near vision zones according to the lens designated designs. The physical optical design profile may include a cylinder profile or a power profile. Method 100 may include an initial optional stage of calculating the optical design profile in 106 being indicative of a specific patient's correction. This stage may be performed by a control unit as will be described further below.

After having created the profile visualization, method 100 may include a further optional stage of applying the physical optical design profile onto at least a portion of at least one front or back surface of the lens in 104. The front and/or the back surface of the lens may contain the physical optical design profile. The physical optical design profile may include a plurality of regions representing the different regions of the optical profile. Therefore, the plurality of regions of the physical optical design profile may be entirely represented on the front or back surface of the lens. Alternatively, a part of the plurality of regions of the physical optical design profile may be represented on the front and a part of the plurality of regions may be represented on the back surface of the lens.

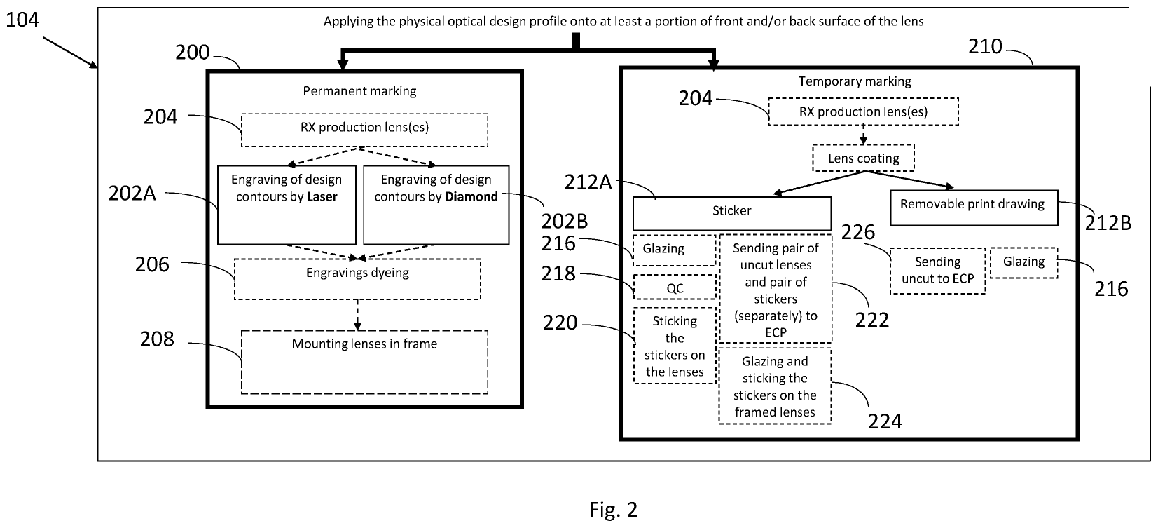

Reference is made to FIG. 2, showing examples of the applying stage 104 of FIG. 1. The application of the physical optical design profile onto at least a portion of the front and/or back surface of the lens may include permanent marking in 200 or temporary marking in 210. The marking can be made in different ways.

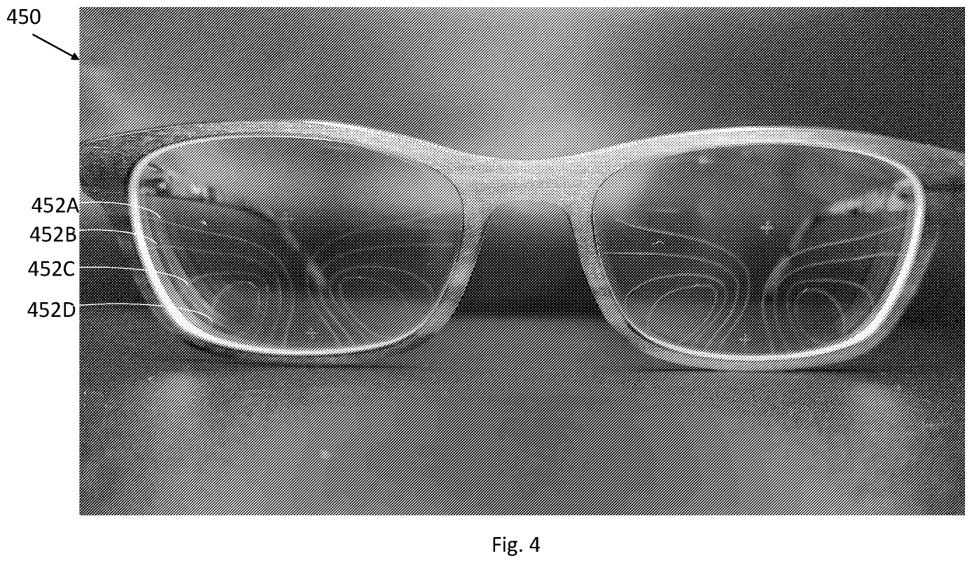

The followings are a few examples of permanent marking:
the physical optical design profile may be subtle lines engraved faintly on the lens surface by laser or by a mechanical engraver as will be illustrated in FIG. 4 further below.
the physical optical design profile may be a permanent or semi-permanent coating on the front and/or back surface of the lens. The semi-permanent coating may be permanent for a predetermined period of time corresponding to the period of time required from the patient to be adjusted and will passively disappear completely after this period of time.

In the specific and non-limiting example of FIG. 2, the permanent marking may include an engraving process in 200. The engraving process 200 may include an optional stage of RX production in 204 of lenses based on the patient's prescription. The optional stage of RX production in 204 may be or may not be a stage of the engraving process. For example, a third party (i.e. lens production entity) may provide the lens(es) after having applied the appropriate optical profile corrections to the lens according to the personalized prescription. The engraving process 200 may then include engraving design contours implemented by laser in 202A or by a mechanical engraving by using a diamond in 202B. The engraving design contours may optionally be followed by engravings dyeing 206 in which color is applied within the defined contours to visualize the different optical regions. The stage of coloring the different regions of the optical profile is optional and the contour may be sufficient to visualize the different optical regions. The dying may be implemented by using any commercially available ink, coating, marker, or lacquer. Additionally or alternatively, the different regions of the optical profile may be patterned differently to visualize the difference between the regions. The application of the pattern may be implemented together with the engraving of the contour by using the same engraving technique or not or thereafter. The marked lens(es) may be then optionally mounted in a frame in 208.

The followings are a few examples of temporary marking:
the physical optical design profile may be a temporary drawing using ink being used for other temporary markings such as the fitting point, optical center, etc. Such printing can be rubbed off when no longer needed;
the physical optical design profile may be in the form of an adhesive physical optical design profile (i.e. a sticker) having a design profile being capable of being positioned in the right orientation on the front and/or back lens surface and being removed after adaptation of the patient whenever desired. The sticker may be implemented in one single piece or by a plurality of pieces being configured to be attached to the lens together or separately.

In the specific and non-limiting example of FIG. 2, the temporary marking 210 includes temporary markings representing the design contour map on the lens surface. The lens(es) to be marked may be mounted in a frame or not. As also described with respect to the permanent marking, the temporary marking process 210 may include an RX production lens(es) in 204 being based on the patient's prescription. If the lens should be covered by regular coatings (hard coat being aimed at protecting the lens surface, anti-reflectance coating, etc.), this is generally performed before the temporary marking. The temporary marking process 210 may include creating a sticker showing actual design contours to be attached to the lens surface in 212A or a removable print drawing on the lens surface describing actual design contours in 212B.

The sticker(s) is/are then applied in 220 on the front and/or back surfaces of the framed lens(es). As described above, the alignment between the sticker and the lens may be made by using markings (e.g. semi-visible) pre-marked on the lens during the RX production lens(es) in 204 or relatively to the frame if the lenses are already mounted in a frame.

Each option of the temporary marking process 210 may include an optional glazing process 216 in which the created lenses are glazed (i.e. the finished lenses are cut to correspond to the frame shape and are fit to the selected frame). The optional glazing process 216 may be followed by an optional Quality Control (QC) process/procedure 218 in which the marking of the lens as well as the correction of the lens, is verified. If temporary marking process 210 includes creating a sticker in 212A, the framed lenses are then marked with the stickers according to semi-visible markings and then the finished marked lenses are sent to the ECP. Alternatively, the uncut lenses and the required number of stickers may be sent to the ECP and then the glazing and sticking may be performed.

If temporary marking process 210 includes creating a removable print drawing in 212B, the lens may be marked with a removable ink before glazing followed by an optional glazing process 216. Alternatively, the uncut marked lens may be sent to the ECP in which the optional glazing process 216 is performed.

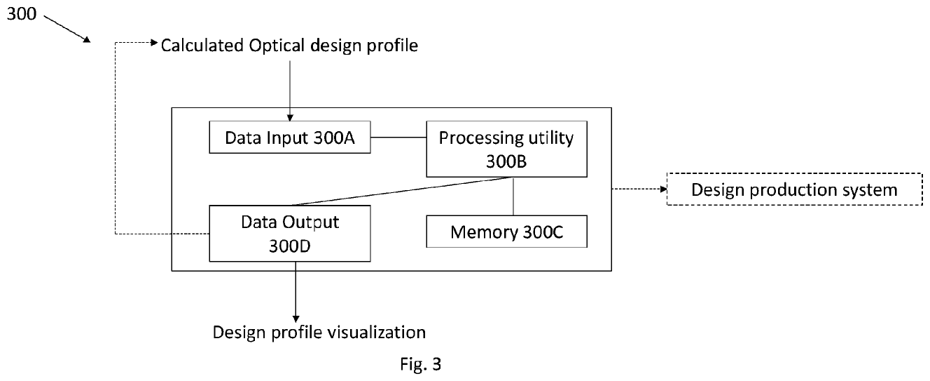

Reference is made to FIG. 3 showing a functional block diagram 300 of a system including a control unit for designing ophthalmic lenses configured and operable according to some embodiments of the present disclosure. In general, control unit 300 may be a processor, a controller, a microcontroller, or any kind of integrated circuit. Control unit 300 is configured generally as a computing/electronic utility including inter alia such utilities as data input 300A and output modules/utilities 300D, memory 300C (i.e. a non-volatile computer-readable medium), and analyzer/data processing utility 300B. Data input 300A is configured and operable for receiving a calculated optical design profile being indicative of a specific patient's correction, and processing utility 300B processes this calculated optical design profile to generate a physical representation data of the optical design profile. The optical design profile is configured and operable to enable design profile visualization and to identify main vision zones including far and near vision zones. The personalized optical design profile may comprise a plurality of contours representing a contour map defining different regions having different parameters (e.g. astigmatism, add power, etc.) of the optical design profile and a plurality of regions defined in between the contours. Data input utility 300A may comprise a communication interface being appropriately configured for connecting the processor utility 300B, via wires or wireless signal transmission (e.g. via communication network(s)), to either a measurement module supplying the calculated optical design profile data or to an external memory (database) where such data have been previously stored. The communication interface may be a separate utility from processor utility 300B or may be integrated within control unit 300. When the communication interface is a separate unit from control unit 300, control unit 300 may comprise a transceiver permitting to be connected to the communication interface and to transmit and/or receive data. When the communication interface is integrated within control unit 300, it may be included in the data input utility 300A and the data output utility 300D of control unit 300. In some embodiments, control unit 300 is connected to a design production system being capable of creating the physical representation of the optical profile, and the communication interface is configured for sending design data being indicative of the physical representation of the optical design profile to the design production system as well as optional design production instructions. Such design production instructions may include design data being indicative of a cylinder profile or a power profile or even of the marking of the plurality of regions defined in between the optical design contours differently. The utilities of the control unit 300 may thus be implemented by suitable circuitry and/or by software and/or hardware components including computer readable code configured for receiving a calculated optical design profile being indicative of a specific patient's correction, and for processing the data to generate a physical representation data of the optical design profile. The features of the present invention may include a general-purpose or special-purpose computer system including various computer hardware components. Features within the scope of the present invention also include computer-readable media for carrying out or having computer-executable instructions, computer-readable instructions, or data structures stored thereon. Such computer-readable media may be any available media, which are accessible by a general-purpose or special-purpose computer system. In this description and in the following claims, a “control unit” is defined as one or more software modules, one or more hardware modules, or combinations thereof, which work together to perform operations on electronic data. The physical layout of the modules is not relevant. The control unit 300 may be configured as an electronic module for collecting, processing data, and optionally sending instructions to a system being capable of creating the physical representation (e.g. sticker or removable print drawing . . . ) of the optical design profile. In some embodiments, control unit 300 is configured and operable to calculate an optical design profile being indicative of a specific patient's correction.

In some embodiments, the preparation of the lens(es) and of the personalized optical design profile is performed in parallel. For example, an order of new spectacles may be received by the system, providing prescription information, frame information, and design information for the specific patient. Control unit 300 and another utility may be configured and operable for calculating all the parameters, providing a lens map with at least some of the contours, and generating instructions to produce this specific lens to a surfacing machine to manufacture the actual lens. Some contours may be selected, and others may be removed for example by leaving only the ones that represent 0.5D contour or 0.25D, etc. The lens map may then be sent to a design production system (i.e. sticker plotter printer) as a graphic vector file (for example, in a DXF format) and there it can be printed.

The term “control unit” should be expansively construed to cover any kind of electronic device with data processing capabilities, including, by way of non-limiting example, personal computers, servers, computing systems, communication devices, processors (e.g. digital signal processor (DSP), microcontrollers, field programmable gate array (FPGA), application specific integrated circuit (ASIC), etc.) and other electronic computing devices. The control unit may comprise a general-purpose computer processor, which is programmed in software to carry out the functions described hereinbelow. Also, operations in accordance with the teachings herein may be performed by a computer specially constructed for the desired purposes or by a general-purpose computer specially configured for the desired purpose by a computer program stored in a computer-readable storage medium. The different elements of the control unit (electronic unit and/or mechanical unit) are connected to each other by wires or are wireless. The software may be downloaded to the processing utility in electronic form, over a network, for example, or it may alternatively be provided on tangible media, such as optical, magnetic, or electronic memory media. Alternatively or additionally, some or all of the functions of the control unit may be implemented in dedicated hardware, such as a custom or semi-custom integrated circuit, or a programmable digital signal processor (DSP). The terms control unit and processor utility are used herein interchangeably and furthermore refer to a computer system, state machine, processor, or the like, designed to perform arithmetic or logic operations using logic circuitry that responds to and processes the instructions that drive a computer. The techniques and system of the present invention can find applicability in a variety of computing or processing environments, such as computer or process-based environments. The techniques may be implemented in a combination of software and hardware. The techniques may be implemented in programs executing on programmable machines such as stationary computers being configured to obtain raw log data, as has also been described above. Program code is applied to the data entered using the input device to perform the techniques described and to generate the output information. The output information can then be applied to one or more output devices. Each program may be implemented in a high-level procedural or object-oriented programming language to communicate with a processed-based system. However, the programs can be implemented in assembly or machine language, if desired.

In other embodiments, the technique of the present invention can be utilized over a network computing system and/or environment. Several computer systems may be coupled together via a network, such as a local area network (LAN), a wide area network (WAN), or the Internet. Each method or technique of the present invention as a whole or a functional step thereof could be thus implemented by a remote network computer or a combination of several. Thus, any functional part of system 300 can be provided or connected via a computer network. In addition, the control unit can also remotely provide processor services over a network. Each such program may be stored on a storage medium or device, e.g., compact disc read-only memory (CD-ROM), hard disk, a magnetic diskette, or similar medium or device, that is readable by a general or special purpose programmable machine for configuring and operating the machine when the storage medium or device is read by the computer to perform the procedures described in this document. The system may also be implemented as a machine-readable storage medium, configured with a program, where the storage medium so configured causes a machine to operate in a specific and predefined manner.

Reference is made to FIG. 4 showing an example of an ophthalmic device 450 including a personalized optical design profile being capable of being applied on a front or a back surface of a lens according to some embodiments of the presently disclosed subject matter. As shown in the figure, the physical permanent optical design profile may be engraved on the front and/or back surface of the lens(es) mechanically or using a laser rendering the optical design visible to the environment. As shown in the figure, the personalized optical design profile includes a plurality of contours 452A-452D representing a cylinder contour map defining different optical regions, thus enabling to visualize the different vision zones. The cylinder contour plots represent the potential blur region of unwanted astigmatism through which the wearer should not gaze. Contours 452A-452D are numbered in the figure to exemplify their position, however, the other marks on the lens also represent contours. The regions being located outside the contour plots define the main vision zones from the far vision zone to the near vision zone, while the region within the cylinder contour plots defines the potentially blur unwanted astigmatism region. In this connection, it should be noted that the optical design contour may define cylinder lines being indicative of the residual cylinder regions through which the patient should not look or power lines being indicative of the regions through which the patient should look. Therefore, the visualization of the optical design assists the patient to understand how to gaze through the various vision zones optimally. The crosses in the figure represent the “fitting point” of the lens (also known as the “fitting cross”). Moreover, it should be noted that the optical profile of each lens as illustrated in the figure is not identical and is personalized according to each own unique lens design.

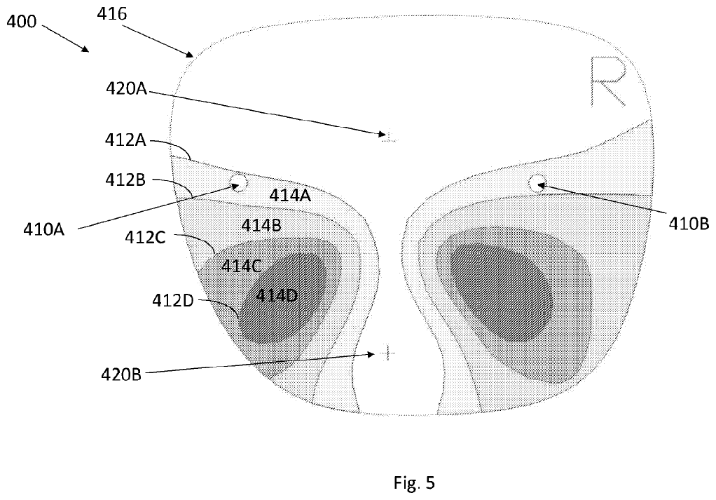

Reference is made to FIG. 5 showing an example of an assembly 400 being capable of being applied on a front or a back surface of a lens according to some embodiments of the presently disclosed subject matter. As shown in the figure, this example indicates that assembly 400 corresponds to the left eye. The assembly has generally a different profile for each eye. In this example, assembly 400 is ready-made to frame shape and allow precise positioning accordingly. As shown, the external contour 416 of the personalized optical design is configured to be precisely aligned with an internal shape of a frame of a lens. In particular, assembly 400 has two marks (e.g. holes) 410A and 410B and/or semi-visible pre-marks 420A and 420B being configured to enable the precise positioning of assembly 400 relative to invisible markings on the lens. Assembly 400 includes a carrier layer being capable of carrying a personalized optical design profile, wherein the personalized optical design profile is configured and operable to enable design profile visualization and to identify main vision zones including far and near vision zones. The carrier layer may have an adhesive side being configured to be attached to the front or the back surface of the lens. As shown in the figure, the personalized optical design profile includes a plurality of cylinder contour plots 412A-412D defining a boundary map of different regions having different parameters of the optical design profile indicating the distribution of an optical property (in this case, astigmatism) across the lens and a plurality of regions 414A-414D defined in between the contours showing the areas of unwanted astigmatism, indicating regions of potential blur/distortion/image swim, enabling to visualizing the different vision zones. Therefore, the visualization of the optical design assists the patient to understand how to gaze through the various vision zones optimally. In this specific and non-limiting example, the personalized optical design profile is colored. However, the configuration of assembly 400 is not limited to such configuration and the personalized optical design profile may be patterned. The colored parts define areas of potential blur through which the wearer should not gaze. Together, the non-colored parts predict the size/width of the vision zones (distance-intermediate-near) through which the wearer should gaze, and after the sticker is attached to the lens, they remain clear. In other words, the stickers represent the “unwanted” regions through which the wearer should not gaze. As also shown in this example, the plurality of regions 414A-414D being indicative of different parameters of the optical design profile is marked differently (in this example by using different colors) indicating the distribution of astigmatism, meaning that the wearer should not gaze through these regions. However, there is an infinite way to distinguish between the different optical regions having different parameters. The regions being located outside the contour map define the main vision zones (the ones that remain clear after the stickers are attached to the lens).

The personalized optical design profile may comprise as in this example a single element carrying the plurality of regions 414A-414D. However, assembly 400 is not limited to this configuration and it may include a plurality of elements configured to be applied together or separately on at least one front or a back surface.

Although for the sake of illustration only contours 412A-412D are numbered and described in the figure to exemplify their position, however, the other symmetric marks on the lens also represent contours and the same description also applies to them. The clear difference in the representation between the different optical profiles of each side of the lens (and of each lens) is shown.

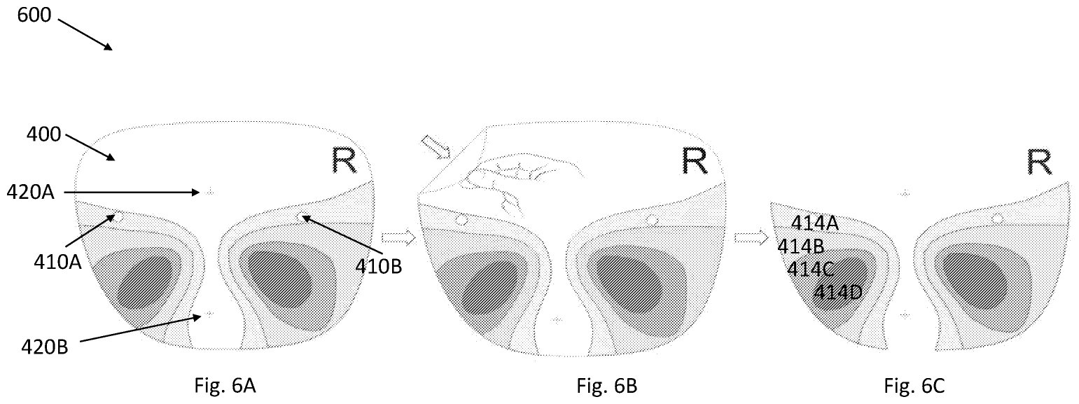

Reference is made to FIGS. 6A-6C showing an example of method 600 of applying the assembly 400 of FIG. 5 according to some embodiments of the presently disclosed subject matter. In FIG. 6A, assembly 400 is attached to the lens via the adhesive carrier layer. The alignment between the assembly 400 and the lens may be made by using holes 410A and 410B and/or semi-visible pre-marks 420A and 420B. In this specific and non-limiting example, the adhesive carrier layer is configured as a top layer on which the plurality of regions 414A-414D are glued together. In FIG. 6B, the adhesive carrier layer is removed, leaving the plurality of regions 414A-414D on the lens surface glued at once as shown in FIG. 6C. Each region 414A-414D may be independent one from another and may be removed separately if desired by the patient at different stages of adaptation to the design. The adhesive layer is configured to prevent any glue residue on the lens surface.

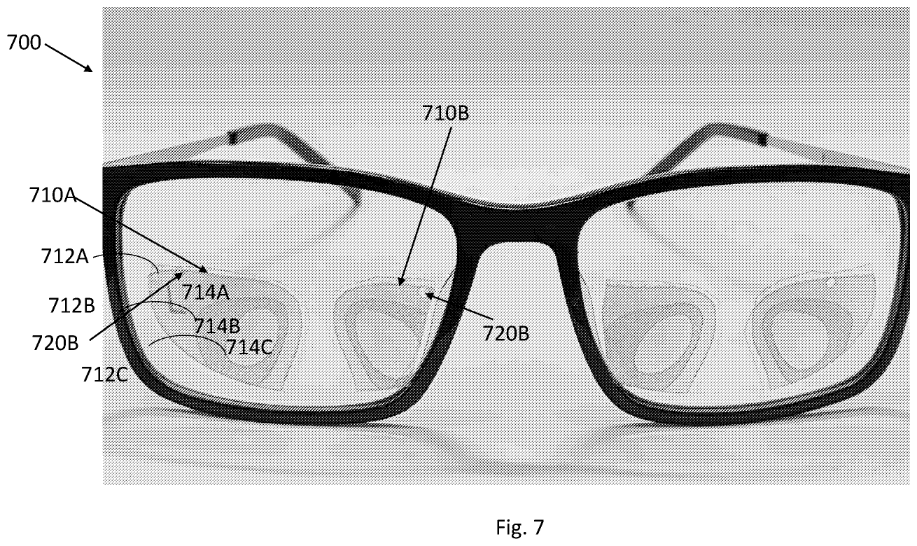

Reference is made to FIG. 7 showing an example of an ophthalmic device 700 including a personalized optical design profile applied on a front surface of a lens according to some embodiments of the presently disclosed subject matter. More specifically, FIG. 7 shows framed spectacle lenses on which the stickers of FIG. 5 have been applied. As shown in the figure, the physical temporary optical design profile defines an assembly being printed on a carrier layer and being attached to the lens surface. In this specific and non-limiting example, the assembly defines two distinct elements 710A and 710B being applied/attached separately according to the marks 720A and 720B onto the lens surface. The two distinct elements 710A and 710B are in this case two separate stickers being applied to the lens surface using the same carrier shaped as the framed lens. The carrier is attached to the lens using the marks for accurate alignment and then it is taken off, leaving the two elements 710A and 710B on the lens. The two distinct elements 710A and 710B, like in the other examples are not symmetrical depending on the own unique design of each vision zone. As shown in the figure, the personalized optical design profile includes a plurality of contours 712A-712C defining a contour map of different regions having different parameters of the optical design profile and a plurality of regions 714A-714C defined in between the contours. The plurality of regions being located outside the contour map is transparent and defines the main vision zones to enable the patient to see therethrough, understand the optical profile of the lens, and to accommodate to the lens. Here again, the optical profile of each lens as illustrated in the figure is not identical and is personalized according to each own unique lens design.

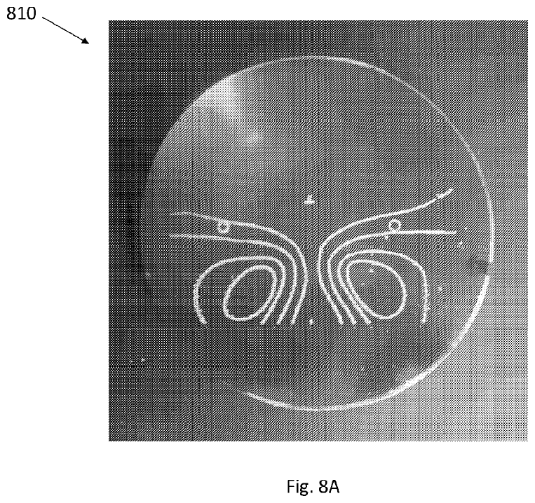

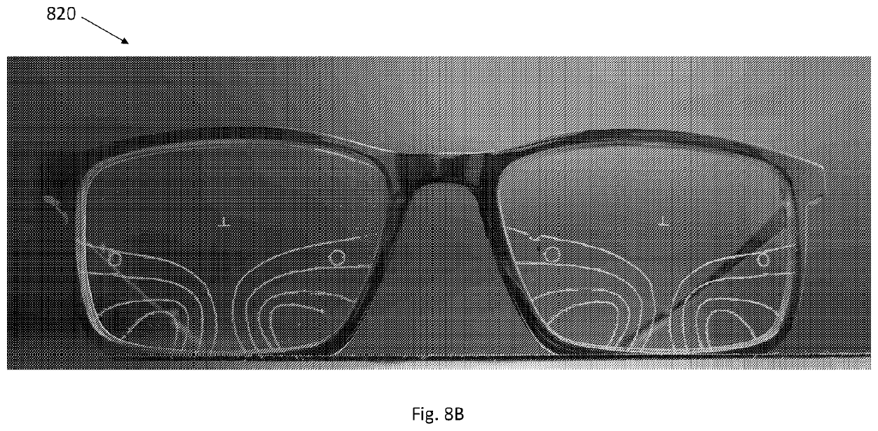

Reference is made to FIG. 8A showing an example of an uncut lens 810 including a personalized optical design profile being applied on the front surface of the lens according to some embodiments of the presently disclosed subject matter. Reference is made to FIG. 8B showing an example of an ophthalmic device 820 including a personalized optical design profile applied on a front surface of a lens according to some embodiments of the presently disclosed subject matter. In these both specific and non-limiting examples, the personalized optical design profile (e.g. the contours) is printed using a removable ink. More specifically, FIG. 8B shows printed-edged lenses mounted on a frame. In this specific and non-limiting example, the printing was carried out on the edged lenses before mounting into the frame. The plurality of regions being located outside the contour map is transparent and defines the main vision zones to enable the patient to see therethrough, understand the optical profile of the lens, and to accommodate to the lens. Here again, the optical profile of each lens as illustrated in the figure is not identical and is personalized according to each own unique lens design.

1. A method for visualizing different vision zones on an ophthalmic lens comprising:
receiving a calculated optical design profile being indicative of a specific patient's correction;
creating a physical representation data of the optical design profile corresponding to a personalized optical design profile; wherein the optical design profile is configured and operable to enable design profile visualization and to identify main vision zones including far and near vision zones.

2. The method of claim 1, characterized by at least one of the following:
the personalized optical design profile comprises a plurality of contours representing a contour map defining different optical regions having different parameters of the optical design profile and a plurality of regions defined in between the contours;
the method further comprises a plying e physical optical design profile onto at least a portion of at least one front or face of the lens; and
the method further comprises calculating the optical design profile being indicative of the specific patient's correction.

3. The method of claim 2, further comprising coloring or patterning the plurality of regions defined in between the optical design contours.

4. The method of claim 3, wherein coloring or patterning the plurality of regions defined in between the optical design contours comprise marking the plurality of regions having different parameters differently.

5. The method of claim 2, wherein the plurality of contours comprises cylinder contour or a power contour.

6. (canceled)

7. The method of claim 2, further comprising applying the physical optical design profile onto at least a portion of at least one front or back surface of the lens, by carrying out at least one of the following:
printing the physical optical design profile onto the at least one front or back surface;
applying a physical permanent of design profile onto the at least one front or back surface;
attaching a physical temporary optical design profile onto the at least one front or back surface; and
applying a physical permanent optical design profile onto the at least one front or back surface, by engraving a physical optical design contour onto the at least one front or back surface mechanically or by using a lager.

8-9. (canceled)

10. The method of claim 7, wherein applying the physical optical design profile onto the at least one front or back surface comprises attaching a physical temporary optical design profile onto the at least one front or back surface, by carrying out at least one of the following:
attaching an adhesive physical optical design profile onto the at least one front or back surface;
attaching a plurality of elements being indicative of a plurality of regions forming the optical profile together on the at least one front or back surface; and
attaching a plurality of elements being indicative of a plurality of regions forming the optical profile separately on the at least one front or back surface.

14. (canceled)

15. An ophthalmic device comprising a lens having a front and a back surface and a personalized optical design profile being applied onto at least one front or a back surface, wherein the personalized optical design profile is configured and operable to enable design profile visualization and to identify main vision zones including far and near vision zones.

16. The ophthalmic device of claim 15, wherein the personalized optical design profile comprises a plurality of contours representing a contour map defining different optical regions having different parameters of the optical design profile and a plurality of regions defined in between the contours.

17. The ophthalmic device of claim 16, characterized by at least one of the following:
the plurality of contours comprises cylinder contour or power contour;
the personalized optical design profile is colored or patterned;
the personalized optical design profile is printed onto the at least one front or a back surface;
the personalized optical design profile is colored or patterned;
the personalized optical design profile is engraved within the at least one front or a back surface;
the personalized optical design profile is permanent;
the personalized optical design profile is engraved within the at least one front or a back surface;
the personalized optical design profile comprises an adhesive layer defining physical optical design profile;
at least one of said personalized optical design profile or the at least one front or a back surface comprises at least one mark being configured to precisely align between the personalized optical design profile and the at least one front or a back surface;
the personalized optical design profile comprises a plurality of elements configured to be applied together on the at least one front or a back surface;
the personalized optical design profile comprises a plurality of elements configured to be applied separately on the at least one front or a back surface;
the device comprises a frame holding the lens, wherein an external contour of the personalized optical design profile is configured to correspond to an internal shape of the frame; and
wherein said lens comprises progressive addition lens.

18. The ophthalmic device of claim 15, wherein the personalized optical design profile is colored or patterned, the plurality of regions being indicative of different parameters of the optical design profile is marked differently.

19-22. (canceled)

23. The ophthalmic device of claim 15, wherein the personalized optical design profile is temporary.

24. The ophthalmic device of claim 15, wherein the personalized optical design profile comprises an adhesive layer defining physical optical design profile, said adhesive physical optical design profile comprising at least one of the following:
a glue layer being capable of coupling between the personalized optical design profile and the at least one front or a back surface; and
a carrier layer being capable of carrying the physical optical design profile and being removed upon attaching the personalized optical design profile onto the at least one from or a back surface.

25-27. (canceled)

28. The ophthalmic device of claim 15, further comprising a frame holding the lens, wherein an external contour of the personalized optical design profile is configured to correspond to an internal shape of the frame, to be precisely aligned with the internal shape of the frame.

29-32. (canceled)

33. An assembly to be applied on a front or a back surface of a lens comprising a carrier layer being capable of carrying a personalized optical design profile, wherein the personalized optical design profile is configured and operable to enable design profile visualization and to identify main vision zones including far and near vision zones.

34. The assembly of claim 33, wherein the personalized optical design profile comprises a plurality of contours representing a contour map defining different optical regions having different parameters of the optical design profile and a plurality of regions defined in between the contours.

35. The assembly of claim 34, wherein the plurality of contours comprises cylinder contour or power contour.

36. The assembly of claim 33, characterized by at least one of the following:
the personalized optical design profile is colored or patterned;
the assembly further comprises a glue layer being capable of coupling between the personalized optical design profile and at least one front or a back surface;
said carrier layer is capable of being removed upon attaching the personalized optical design profile onto at least one front or a back surface;
the personalized optical design profile comprises at least one mark being configured to precisely align between the personalized optical design profile and at least one front or a back surface;
the personalize optical design profile comprises a plurality of elements configured to be applied together on at least one front or a back surface; and
the personalized optical design profile comprises a plurality of elements configured to be applied separately on at least one front or a back surface.

37. The assembly of claim 36, wherein the personalized optical design profile is colored or patterned, the plurality of regions being indicative of different parameters of the optical design profile is marked differently.

38-40. (canceled)

41. The assembly of claim 33, wherein the personalized optical design profile comprises at least one mark being configured to precisely align between the personalized optical design profile and at least one front or a back surface, an external contour of the personalized optical design being configured to be precisely aligned with an internal shape of a frame of a lens.

42-43. (canceled)

44. A system for designing ophthalmic lenses, the system comprising: a control unit being configured and operable to receive a calculated optical design profile being indicative of a specific patient's correction; creating a physical representation data of the optical design profile corresponding to a personalized optical design profile; wherein the optical design profile is configured and operable to enable design profile visualization and to identify main vision zones including far and near vision zones.

45. The system of claim 44, characterized by at least one of the following:
the personalized optical design profile comprises a plurality of contours representing a contour map defining different optical regions having different parameters of the optical design profile and a plurality of regions defined in between the contours;
the system farther comprises a communication interface being configured for sending design data being indicative of the physical representation data of the optical design profile to a design production system;
said creating of the physical representation data of the optical design profile comprises providing a design data being indicative of the marking of the plurality of regions defined in between the optical design contours differently;
said creating of the physical representation data of the optical design profile comprises creating a cylinder profile or a power profile; and
said control unit is configured and operable to calculate an optical design profile being indicative of a specific patient's correction.

46-49. (canceled)
